(19) United States
(12) Patent Application Publication
(10) Pub. No.: US 2003/0100401 A1
(43) Pub. Date: May 29, 2003

(54) System and method for controlling engine torque when shifting from idle state

(76) Inventor: Joung-Chul Kim, Ansan-city (KR)

Correspondence Address: Pennie & Edmonds, LLP, 3300 Hillview Avenue, Palo Alto, CA, 94304, US

(21) Appl. No.: 10/295,599

(22) Filed: Nov. 15, 2002

(30) Foreign Application Priority Data
Nov. 28, 2001 (KR) 2001-0074443

(51) Int. Cl. B60K 41/06

(52) U.S. Cl. 477/107; 477/109

(57) ABSTRACT

The present invention provides a system and method for controlling engine torque when shifting from an idle state in an automatic transmission, in which the system and method improve, in a simple manner, a shift feel and a durability of friction elements such as clutches in the transmission. If idle conditions are satisfied and a change in a shift range by a shift lever is detected, an opening degree of a throttle valve and an engine speed are detected, and an engine torque control value is calculated from a mapping table established for the shift range change by the shift lever is positioned, after which engine torque is controlled based on the engine torque control value.

### FIELD OF THE INVENTION

The present invention relates to an engine control system and method. More particularly, the present invention relates to a system and method for controlling engine torque when shifting from an idle state in an automatic transmission.

### BACKGROUND OF THE INVENTION

To shift into a gear or shift range (for example, one of P,R,N,D,2,L ranges) a driver operates a shift lever, thereby activating a valve, which supplies hydraulic pressure (generated by a hydraulic pump) to specific lines. If shifting into a shift range that has more than one speed (e.g., D and 2), and if driving conditions are changed as a result of variations in the driving speed, such as the throttle opening, etc., a shift control system controls the hydraulic pressure through a plurality of solenoid valves. This operates various operational elements of a gearshift mechanism so that shifting is automatically controlled to a suitable speed, thereby providing convenience to the driver.

If engine torque is altered when shifting into a desired range using the shift lever, such as N to D, N to R, D to R, R to D, D to N, and R to N, hydraulic pressure is controlled a second time (following the initial shifting into the desired range) by operation of the solenoid valves, to maintain a smooth shifting motion. However, such conventional shift control methods have limitations. As a result, the degree to which a smooth shifting motion can be improved is restricted.

Further, if the accelerator pedal is operated before shifting has been completed (following driver manipulation of the shift lever), engine torque is abruptly increased. In such an instance, an attempt is made to quickly engage the required elements using a substantially increased line pressure and duty pressure. However, if the accelerator pedal is depressed by a significant amount to significantly open the throttle, a substantial shift or jerk shock occurs. Typically, this is both uncomfortable for the driver and may also damage the transmission clutches.

### SUMMARY OF THE INVENTION

The present invention provides a system and method for controlling engine torque when shifting from an idle state in an automatic transmission. Engine torque control time and engine torque levels for each shift range are used to construct a mapping table of engine torque and throttle opening. The mapping table is then used to stabilize engine torque when shifting from an idle state. This enhances the level of shift control flexibility and reduces generation of shift shock, thereby generating a smooth shifting motion.

The system determines if idle conditions of a vehicle are satisfied and if a change in a shift range by a shift lever is detected. The system then detects a throttle opening and an engine speed if the idle state conditions are satisfied and a change in a shift range by the shift lever is detected. An engine torque control value is calibrated from a mapping table established with respect to a shift range change by the shift lever. Engine torque is controlled by regulating a fuel injection amount and ignition timing using the calculated engine torque control value.

The system includes a shift range detector for detecting a shift range selected by a shift lever, a throttle opening detector for detecting an opening degree of a throttle valve, and an engine speed detector for detecting an engine speed.

The system also includes a vehicle speed detector for detecting a speed at which a vehicle is traveling. In addition, the system includes an actuator for controlling a hydraulic pressure in a transmission to realize shifting into a specific shift range; an engine control unit controlling an engine torque. Furthermore, the system includes a transmission control unit for controlling an operation of the actuator based on signals received from the detectors, and outputting an engine torque control signal to the engine control unit. If idle conditions are satisfied and a change in a shift range by the shift lever is detected, the transmission control unit calculates, after a throttle opening and an engine speed are detected, an engine torque control value corresponding to the throttle opening and the engine speed. This is calculated from a mapping table established with respect to the change in the shift range. The transmission control unit then outputs the engine torque control signal to the engine control unit.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a block diagram of an engine torque control system according to a preferred embodiment of the present invention; and

FIG. 2 is a flow chart of an engine torque control method used in the engine torque control system of FIG. 1, according to a preferred embodiment of the present invention.

### DETAILED DESCRIPTION OF THE PREFERRED EMBODIMENTS

Preferred embodiments of the present invention will now be described in detail with reference to the accompanying drawings.

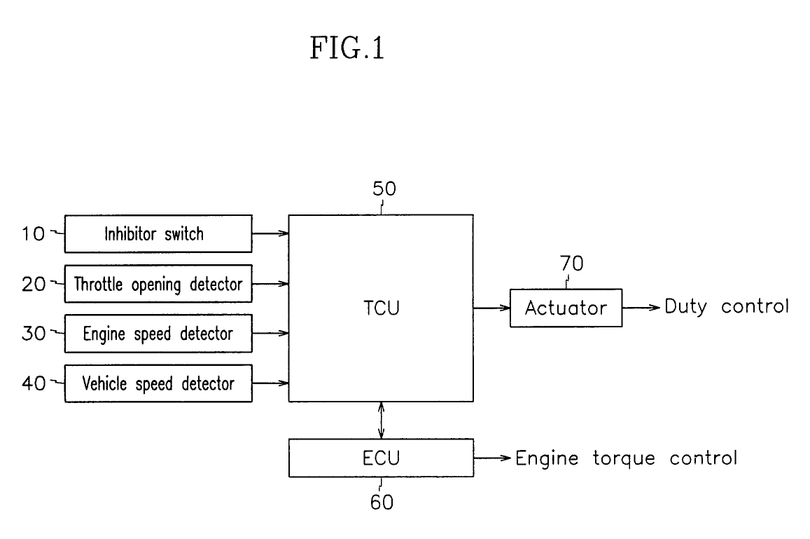

With reference to FIG. 1, an engine torque control system according to a preferred embodiment of the present invention includes an inhibitor switch 10, a throttle opening detector 20, an engine speed detector 30, a vehicle speed detector 40, a transmission control unit (TCU) 50, an engine control unit (ECU) 60, and an actuator 70.

The inhibitor switch 10 detects a position of a shift lever in a specific shift range and outputs a corresponding signal to the TCU 50. The throttle opening detector 20 detects changes in an opening of a throttle valve, which is linked to an accelerator pedal, and outputs a corresponding signal to the TCU 50. The engine speed detector 30 detects an engine speed through calculations of a rotational speed of a crankshaft, and outputs a corresponding signal to the TCU 50. The vehicle speed detector 40 detects a present vehicle speed through calculations of a speed of a transfer driven gear, and outputs a corresponding signal to the TCU 50.

The TCU 50 constructs and stores a mapping table using an engine torque control time and engine torque levels at each shift range according to an engine speed and a throttle valve opening for each shift range. Also, if a change in the shift range position of the shift lever is detected, the TCU 50 calculates line pressures and duty pressures for performing shifting into the selected target shift range. Finally, the TCU 50 calculates an engine torque control value from the constructed mapping table, and then performs engine torque control through the ECU 60. Based on an engine torque control signal received from the TCU 50, the ECU 60 calculates an amount of fuel required for injection into a combustion chamber, and required ignition timing, and then performs fuel injection and ignition using the calculated values to control engine torque. The TCU 50 and the ECU 60 may comprise microprocessors and associated hardware and software as may be selected by a person of ordinary skill in the art that operate using programs for performing the above described functions.

The actuator 70 regulates the supply of hydraulic pressure in a transmission to enable shifting into the shift range selected by the shift lever. The actuator 70 performs this function using a line pressure control signal and a duty pressure control signal received from the TCU 50. The actuator 70 may be configured in a variety of different ways depending on transmission type. Since such different configurations are well know to those skilled in the art, a detailed description will not be provided.

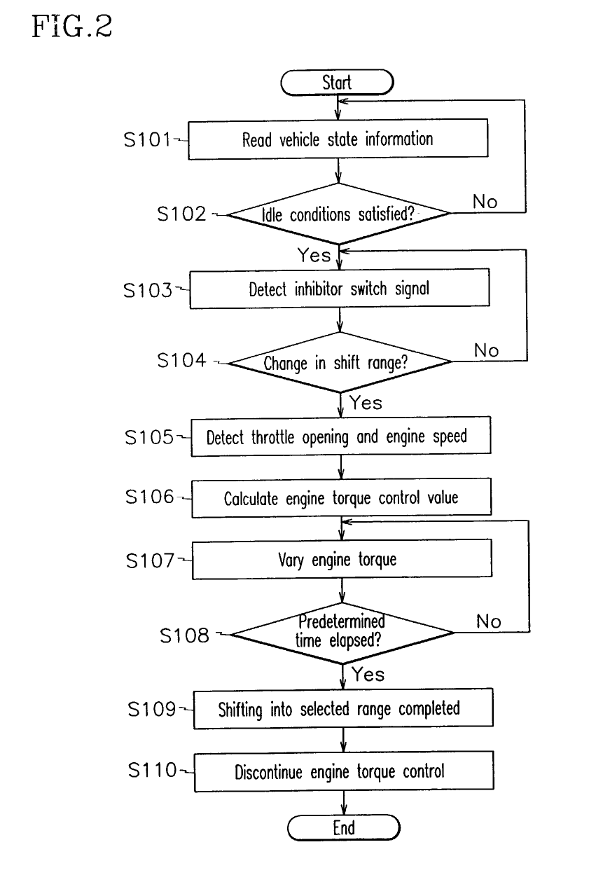

As illustrated in FIG. 2, while the engine is running, the TCU 50 reads vehicle state information at step S101. The vehicle state information includes shift lever position information, throttle opening information, engine speed information, and vehicle speed information. Next, it is determined by the TCU 50 if the vehicle speed is zero, and if the throttle valve opening and the engine speed satisfy engine idle conditions, that is, if the throttle valve opening and engine speed are within predetermined ranges, at step S102.

If the vehicle speed is zero and the idle conditions are satisfied (S102—Yes), the signal of the inhibitor switch 10 is detected at step S103 to determine if there has been a change in the shift range by the shift lever at step S104. If there has been no change in the shift range by operation of the shift lever (S104—No), a present control state is maintained.

However, if it is determined that the shift range has been changed by shift lever operation (S104—Yes), for example, if it is determined that the shift lever has been re-positioned from one range into another range such as N to D, N to R, D to R, R to D, D to N, or R to N, the TCU 50 determines the line pressure and duty pressure within the system and shifts into the selected range by operating the actuator 70. In addition to such normal operation, the TCU 50 also detects changes in the throttle opening and engine speed at step S105, and calculates an engine torque control value with respect to the detected range from the established mapping table at step S106.

The TCU 50 then outputs an engine torque control signal based on the engine torque control value to the ECU 60 using CAN (Computer Area Network) communications. The ECU 60 calculates a fuel injection quantity and ignition timing using the calculated control value, and increases or decreases engine torque using the calculated fuel injection quantity and ignition timing at step S107.

Although the TCU 50 may output the engine torque control signal as soon as a change in the position of the shift lever is detected, it is preferable that the engine torque control signal is output by the TCU 50 after a predetermined time has elapsed after such a detection is made.

Since the manner in which engine torque is increased and decreased to a predetermined level by varying fuel injection amounts and varying ignition timing are well known to those skilled in the art, a detailed description thereof will not be provided.

Subsequently, it is determined whether the predetermined time has elapsed at step S108. If the predetermined time has elapsed (S108—Yes), it is determined that shifting into the shift range selected by the shift lever is completed at step S109. Engine torque control is then discontinued at step S110.

It should be appreciated, however, that the determination of whether shifting into the selected range is completed need not necessarily be performed by checking whether a predetermined time has elapsed. For example, this may be performed by calculating a turbine speed at the end of synchronization, and determining if a present turbine speed falls within a predetermined speed range, which includes the calculated turbine speed when synchronization is completed. If such a determination is made, it is determined that shifting into the selected shift range is completed.

In a preferred embodiment, a mapping table is constructed at each shift range for engine torque control with respect to a selected shift range, an engine speed, and throttle opening. If it is determined that the shift lever has been re-positioned into another shift range from an idle state, control is performed to minimize variations in engine torque using an engine torque control value of the mapping table. As a result, the control flexibility is increased and smooth shifting motion is improved. In addition, shift shock and the damage to clutches resulting from the occurrence of shift shock or a jerking motion is reduced. In addition, damage to clutches resulting from the occurrence of shift shock are also reduced.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A method for controlling engine torque when shifting in an automatic transmission, comprising:
determining if idle conditions of a vehicle are satisfied;
determining if a change in a shift range by a shift lever is detected;
detecting a throttle opening and an engine speed if the idle conditions are satisfied and a change in a shift range by the shift lever is detected;
calculating an engine torque control value from a mapping table established with respect to a shift range change by the shift lever; and
controlling engine torque by regulating a fuel injection amount and ignition timing using the engine torque control value.

2. The method of claim 1, wherein the mapping table is established based on a throttle opening and an engine speed with respect to each shift range change by the shift lever.

3. The method of claim 1, wherein the idle conditions include a vehicle speed of zero, and a throttle opening and an engine speed within an idle range.

4. The method of claim 1, wherein the engine torque is controlled for a predetermined time.

5. The method of claim 1, wherein the engine torque is controlled until a turbine speed reaches a predetermined speed range that includes a target turbine speed.

6. A system for controlling engine torque when shifting in an automatic transmission, comprising:
a shift range detector detecting a shift range selected by a shift lever;
a throttle opening detector detecting an opening degree of a throttle valve;
an engine speed detector detecting an engine speed;
a vehicle speed detector detecting a speed at which a vehicle is traveling;
an actuator controlling a hydraulic pressure in an automatic transmission to realize shifting into a specific shift range;
an engine control unit controlling an engine torque; and
a transmission control unit controlling an operation of the actuator based on signals received from the shift range detector, throttle opening detector, engine speed detector and vehicle speed detector, and outputting an engine torque control signal to the engine control unit;
wherein if idle conditions are satisfied and a change in a shift range by the shift lever is detected, the transmission control unit calculates, after a throttle opening and an engine speed are detected, an engine torque control value corresponding to the throttle opening and the engine speed from a mapping table established with respect to the change in the shift range, then the transmission control unit outputs the engine torque control signal to the engine control unit.

7. The system of claim 6, wherein the engine control unit controls engine torque by regulating fuel injection and ignition timing based on the engine torque control signal received from the transmission control unit.

8. The system of claim 6, wherein the mapping table is established based on a throttle opening and an engine speed with respect to each shift range change by the shift lever.

9. The system of claim 6, wherein the idle conditions include a vehicle speed of zero, and a throttle opening and an engine speed of an idle range.

10. The system of claim 7, wherein the engine control unit controls engine torque until a turbine speed reaches a predetermined speed range that includes a target turbine speed.
